(19) United States
(12) Patent Application Publication
(10) Pub. No.: US 2025/0225560 A1
(43) Pub. Date: Jul. 10, 2025

(54) THRESHOLD-BASED SENSING DURING COMMERCE SESSION AT A PHYSICAL LOCATION

(71) Applicant: The Toronto-Dominion Bank, Toronto (CA)

(72) Inventors: Hitesh BAJAJ, Duluth, GA (US); Kaitlyn ROLLAND, Kittanning, PA (US); Mallika DASWANI, Philadelphia, PA (US); Richard Alan RYBA, Sunbury, OH (US); Milos DUNJIC, Oakville (CA)

(73) Assignee: The Toronto-Dominion Bank, Toronto (CA)

(21) Appl. No.: 18/408,162

(22) Filed: Jan. 9, 2024

(51) Int. Cl. G06Q 30/0601; G06V 30/146

(52) U.S. Cl. CPC G06Q 30/0629; G06Q 30/0641; G06V 30/147

(57) ABSTRACT

According to an aspect there is provided a computer-implemented method. The method may include: detecting, based on an output of a sensor, engagement with an item during a session at a physical location; obtaining a value parameter for the item; retrieving a threshold from stored threshold definition data; evaluating the value parameter using the retrieved threshold; and based on a result of the evaluation, selectively triggering a notification at a device associated with the threshold definition data.

### TECHNICAL FIELD

The present application relates to sensing systems and, more particularly, to systems and computer-implemented methods for triggering computing operations based on sensed conditions at a physical location.

### BACKGROUND

Ambient processing systems are sometimes deployed at a physical location such as a store to allow customers to skip a traditional checkout process. Often, a customer will tap a credit card or app at a reader when they enter a store and the ambient processing system monitors which items the customer leaves the store with and then automatically processes a transfer for such items. Ambient processing systems offer a cashier-less checkout experience. In this way, a customer does not have to participate in a traditional checkout process-they simply walk out of the store with any items that are to be purchased.

Ambient processing systems offer numerous benefits including, for example, reducing the possibility of theft, increasing the speed of checkout, and reducing human resource requirements. However, ambient processing systems present many challenges. For example, the lack of a traditional checkout process means that some customers may find it difficult to track the quantum of purchases being made. Further, ambient processing of transactions presents challenges since some customers may inadvertently walk out of a physical location associated with a merchant with goods that were not yet purchased without realizing that they lacked sufficient resources to complete the transaction.

### BRIEF DESCRIPTION OF THE DRAWINGS

Embodiments are described in detail below, with reference to the following drawings:

FIG. 1 is a plan view of an ambient commerce system at an ambient commerce premises illustrating an operating environment of an example embodiment;

FIG. 2 is a schematic operation diagram illustrating a first operating environment;

FIG. 3 is a schematic operation diagram illustrating a second operating environment;

FIG. 4 is a high-level schematic diagram of an example computer device;

FIG. 5 shows a simplified organization of software components stored in a memory of the example computer device of FIG. 4;

FIG. 6 is a flowchart showing operations performed by a computer system in triggering a notification;

FIG. 7 is a flowchart showing operations performed by a computer system in triggering a notification;

FIG. 8 is a flowchart showing operations performed by a computer system in configuring a notification to indicate an alternative item;

FIG. 9 is a flowchart showing operations performed by a computer system in providing a stepped-up pre-authorization;

FIG. 10 is an example notification in accordance with example embodiments; and

FIG. 11 is an example notification in accordance with example embodiments.

Like reference numerals are used in the drawings to denote like elements and features.

### DETAILED DESCRIPTION OF VARIOUS EMBODIMENTS

According to an aspect there is provided a computer-implemented method. The method may include: detecting, based on an output of a sensor, engagement with an item during a commerce session at a physical location; obtaining a value parameter for the item; retrieving a threshold from stored threshold definition data; evaluating the value parameter using the retrieved threshold; and based on a result of the evaluation, selectively triggering a notification at a device associated with the threshold definition data.

In some implementations, the method may include: receiving, via an interface, the threshold definition data, the threshold definition data defining thresholds for each of a plurality of categories; and determining a category of the item. Retrieving the threshold from the stored threshold definition data may include retrieving the threshold based on the category of the item.

In some implementations, the threshold may represent a balance associated with an account.

In some implementations, the sensor is provided on smart glasses associated with the threshold definition data.

In some implementations, a computing system performing the method does not interact with a merchant system.

In some implementations, evaluating the value parameter using the retrieved threshold includes determining that the item should not be purchased based on the threshold definition data. The notification may be triggered in response to determining that the item should not be purchased based on the threshold definition data. The notification may indicate that the item should not be purchased.

In some implementations, the notification includes one or more of: a suggestion of an alternate item; a selectable option to access a borrowed resource; a selectable option to split a transfer into multiple parts; and a selectable option to access an accumulated resource.

In some implementations, detecting engagement with the item includes detecting a dwell at a region associated with the item.

In some implementations, detecting engagement with the item includes determining that the item has been added to a shopping receptacle.

In some implementations, the sensor may be a camera. Obtaining the value parameter may include obtaining the value parameter from camera data.

In some implementations, obtaining the value parameter from camera data may include performing optical character recognition on an image defined by the camera data.

In some implementations, the method may include: identifying an alternate item depicted in the camera data; determining that the alternate item and the item for which engagement was detected are substitutable; and determining, from the camera data, that the alternate item has a preferred value parameter. The notification may indicate that the item for which engagement was detected should be substituted with the alternate item.

In some implementations, the method may include initializing a pre-authorization of a first amount to initiate the commerce session. The threshold may be based on the first amount. Evaluating the value parameter using the retrieved threshold may include determining that the first amount is insufficient based on the value parameter. The method may further include, in response to determining that the first amount is insufficient based on the value parameter, initializing a pre-authorization of a second amount.

In another aspect, there is provided a computing system. The computing system may include a sensor for sensing one or more parameters of a commerce session at a physical location. The computing system may include a processor coupled to the sensor. The computing system may include a memory coupled to the processor. The memory may store processor-executable instructions which, when executed, cause the processor to perform a method defined herein. For example, in an implementation, the processor-executable instructions may cause the processor to: detect, based on an output of the sensor, engagement with an item during the commerce session at the physical location; obtain a value parameter for the item; retrieve a threshold from stored threshold definition data; evaluate the value parameter using the retrieved threshold; and based on a result of the evaluation, selectively trigger a notification at a device associated with the threshold definition data.

In another aspect, there is provided a computer-readable storage medium. The computer-readable storage medium may be a non-transitory computer-readable storage medium. The computer-readable storage medium may have stored thereon instructions which, when executed, configure a processor and/or a computer system to perform a method described herein.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . and . . . ” is intended to cover any one or more of the listed elements, including any one of the listed elements alone, any sub-combination, or all of the elements, without necessarily excluding any additional elements, and without necessarily requiring all of the elements.

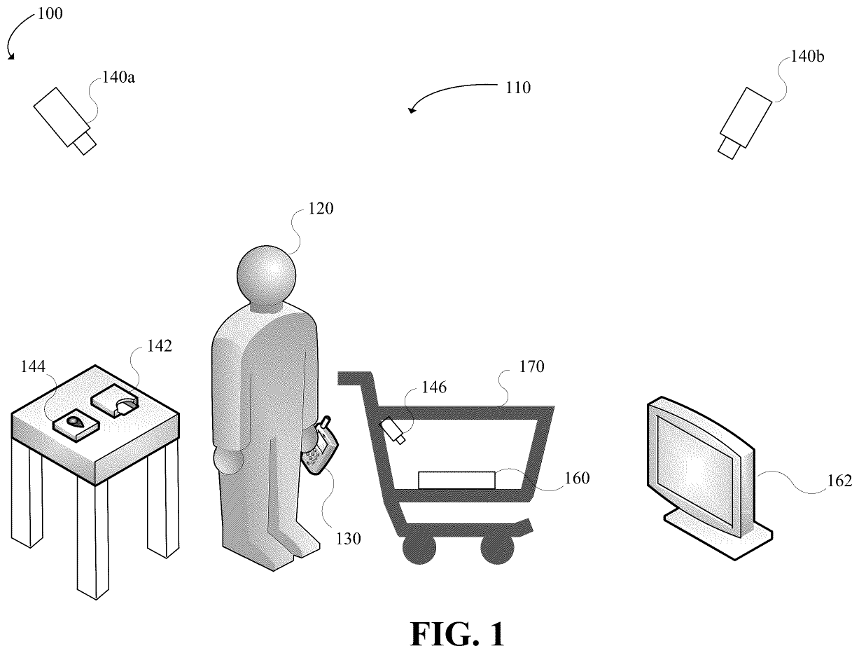

FIG. 1 is a plan view of a system, which may be referred to as an ambient commerce system 100. The ambient commerce system 100 may be a system partially situated at or otherwise associated with an ambient commerce premises 110. The ambient commerce premises 110 may be a merchant location such as a store. The store may be a bricks-and-mortar establishment at which a customer may physically attend to shop. By way of example, the store may be or include any one or more of a grocery store, a department store, a clothing store, a thrift shop, a sporting goods store, a big box store, a pet store, a discount store, a warehouse store, a convenience store, or a store of another type.

The ambient commerce system 100 may be referred to as a cashier-less checkout system, an ambient checkout system, a “just-walk-out” system or “grab and go” system. The ambient commerce system 100 includes one or more sensors which are used by the ambient commerce system to identify one or more items 160, 162 that are sold at the ambient commerce premises 110 and that are being or may be purchased by an entity 120 such as a customer who is on site at the ambient commerce premises 110. In at least some implementations, the sensors may be used by the ambient commerce system to identify an item of interest to a customer. In at least some implementations, the sensors may be used by the ambient commerce system to identify an item that a customer is engaged with.

The items may be or include any products. By way of example, the items 160, 162 that are available for purchase via the ambient commerce system 100 may be or include groceries, electronic goods, sporting goods, accessories, clothing, or goods of another type.

The ambient commerce system 100 may include various sensors. One or more of the sensors may be on site at the ambient commerce premises 110. The sensors may generate respective sensor outputs which are used by the ambient commerce system 100 to facilitate ambient commerce. For example, the sensors may be or include one or more cameras 140a, 140b. The cameras may be located at various regions throughout the ambient commerce premises 110. In some implementations, the cameras 140a, 140b are part of a camera array or camera grid. The camera array or grid may provide complete or near complete coverage of all areas of the ambient commerce system 100 and the cameras may be configured to provide some overlap in camera coverage. In some implementations, each of the cameras may include multiple image sensors or the cameras may be configured in multiples such as pairs to enable the ambient commerce system 100 to determine and evaluate depth information as part of its analysis.

The sensors may include a receptacle contents detector 146. The receptacle contents detector 146 may be provided on or associated with a particular shopping receptacle 170. The particular shopping receptacle 170 is a container or other receptacle which may be used for holding or transporting goods while shopping. The particular shopping receptacle may, for example, be a shopping cart, shopping basket, shopping bag, or shopping bin.

The receptacle contents detectors 146 may be or include any one or more of: a camera, a barcode reader, a quick response (QR) code reader, a wireless tag reader such as a radio frequency identifier (RFID) reader or a sensor of another type.

In some implementations, one or more of the items that may be available for purchase may include a physical feature which facilitates identification of that item by one of the sensors. By way of example, the items may include a barcode which may be scanned by a barcode reader or camera, a QR code which may be scanned by a QR code reader or scanner, and/or a wireless tag such as an RFID tag.

The sensors included in the ambient commerce system 100 may include other types of sensors and readers including, for example, a biometric reader 144 and/or a token reader 142. The biometric reader 144 and/or the token reader 142 may be identity sensors. Identity sensors are sensors that are used to verify the identity of an entity 120. That is, identity sensors may be used to associate an entity 120 on the ambient commerce premises 110 with a profile or account.

The biometric reader 144 may be or include a fingerprint sensor, a facial recognition sensor, a retina scanner, or a sensor of another type. The token reader 142 may be a physical card reader such as a payment card reader including a credit card reader or debit card reader. In some implementations, the token reader 142 may be or include a near field communication (NFC) reader. The token reader 142 may be configured, in some implementations, to wirelessly read a token which may be stored on an electronic device 130 associated with an entity 120 or which may be stored on a physical card.

The sensors included in the ambient commerce system 100 may also include a microphone. The microphone may be used, for example, to verify the identity of an entity using a voiceprint. That is, the microphone may be used as an identity sensor.

The sensors included in the ambient commerce system 100 may be or include a gaze detection sensor. The gaze detection sensor may be or include one or more cameras. The gaze detection sensor may be an eye gaze detection sensor. The gaze detection sensor may be used to identify at item that the entity 120 is currently looking at. The gaze detection sensor may detect where the entity 120 is looking by identifying a portion of an ambient commerce premises 110 being looked at from an angular direction of a head and/or eyes. In some implementations, the gaze detection sensor may be configured to identify a gaze vector and an item may be identified if it is in a direction associated with the gaze vector.

The ambient commerce system 100 may be configured to detect the identity of an entity 120 and/or items 160, 162 that are being purchased using any one of a number of techniques. For example, in some implementations, identity may be detected using an identity sensor. For example, the biometric reader 144 and/or token reader 142 and/or one or more of the cameras 140a, 140b may be used to determine identity of an entity when the entity enters the ambient commerce premises 110. By way of example, in some implementations, upon entering the ambient commerce premises, the entity 120 may tap their electronic device at a token reader 142 which may then read a token from the electronic device which uniquely identifies the customer. In some implementations, multiple authentication techniques may be used to verify the identity of the customer. For example, the ambient commerce system may use two or more of: facial recognition; token acquisition and verification; retinal scanning; fingerprint scanning; and voiceprint scanning.

Further, in some implementations, identity of an entity 120 may be determined or verified using a shared secret such as a personal identification number (PIN) or secret code or phrase. The ambient commerce system 100 may include an input device for receiving input of the shared secret from an entity 120.

In some implementations, the ambient commerce system 100 may include or operate in cooperation with an electronic device 130 associated with an entity 120. The electronic device 130 may be a portable electronic device such as a smartphone, smartwatch or other wearable electronic device. The electronic device 130 may, in some implementations connect with the ambient commerce system 100 when it is within a geolocation or geofence associated with the ambient commerce system 100. For example, when the electronic device 130 is at the ambient commerce premises, it may connect with the ambient commerce system 100. Such communication may be performed via a long or short range communication protocol. In some implementations, the electronic device 130 may have an ambient commerce application stored thereon which is configured to enable the electronic device 130 to communicate with the ambient commerce system 100.

In at least some implementations, the electronic device 130 may be used to identity an entity 120. For example, the electronic device 130 may share its location (as determined from a location subsystem such as a GPS subsystem) with the ambient commerce system 100. The ambient commerce system 100 may determine that a particular entity 120 is on site at the ambient commerce premises when the location of that entity's electronic device is within a geofence defined for the ambient commerce premises. Additionally or alternatively, in some implementations the electronic device 130 may connect to the ambient commerce system 100 via a short range communication protocol such as NFC, Bluetooth™, WiFi, or a short range communication protocol of another type. In such implementations, the ambient commerce system may determine that a particular entity 120 is on site at the ambient commerce premises when the location of that entity's electronic device is in communication range of a short-range communication system associated with the ambient commerce premises.

In some implementations, the ambient commerce system 100 may use a biometric sensor associated with an entity's electronic device to further verify that a particular entity 120 is at the ambient commerce premises. For example, the ambient commerce system may, when the electronic device is determined to be on site, cause the electronic device to prompt the entity for input of a shared secret or a biometric such as a fingerprint. In this way, the ambient commerce system determines that the electronic device is on site and is being used by a particular entity 120. This may, for example, prevent a fraudster from circumventing the ambient commerce system by stealing another person's electronic device.

The electronic device 130 associated with an entity 120 may be used for other purposes instead of or in addition to identification and customer detection. For example, the electronic device 130 may include an output interface such as a display screen or speaker and the output interface may be used for outputting notifications generated by the ambient commerce system or by another system associated with the ambient commerce system.

In some implementations, the ambient commerce system 100 may perform a computer operation in response to detecting engagement of the entity with an item. For example, the ambient commerce system 100 may output a notification on an electronic device 130 associated with an entity or may output notifications on an electronic device associated with an in-store representative. In some implementations, the ambient commerce system 100 may control an electrically controlled exit prevention device such as an electrically controlled gate associated with an exit for the ambient commerce premises as a direct result of the determination that the entity is engaged with an item. The electrically controlled gate may be, for example, an electrically controlled turnstyle. The electrically controlled gate may be controlled to, for example, prevent an entity from leaving the physical premises with an item that a system determines that the entity should not or cannot purchase. For example, the entity may be prevented from leaving the store with an item if the purchase of that item would cause a budget to be exceeded.

Engagement may be detected based on the output of one or more of the sensors. By way of example, engagement may be detected when the ambient commerce system determines, based on the output of a sensor such as a camera 140a, 140b, that an entity has dwelled within a geofence associated with a first item. By way of further example, engagement with an item may be detected when the ambient commerce system determines, based on the output of a sensor such as a receptacle contents detector 146, that the item has been added to a shopping receptacle. By way of further example, engagement with an item may be detected based on gaze. For example, when the ambient commerce system determines that the entity is looking at the item, which may be determined from the output of a gaze detection sensor, it may determine that the customer is engaged with the item.

In some implementations, the ambient commerce system 100 may determine a customer's intent (such as intent to purchase an item) or engagement with an item based on a sensor provided on or in a wearable device. The wearable device may be smart glasses or a smart watch or another wearable device. The wearable device may include, for example, a camera. The wearable device may be, for example, an Apple™ Vision Pro™, Google™ Glasses, a Meta™/Ray-Ban™ Wayfarer™, or smart glasses of another type.

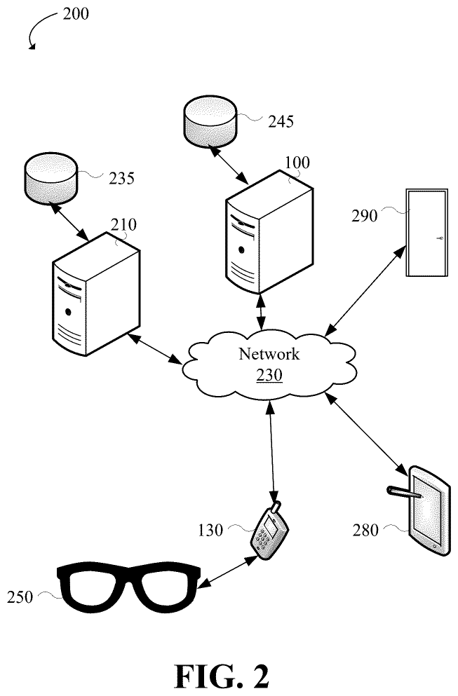

FIG. 2 is a schematic operation diagram illustrating an operating environment of an example embodiment. FIG. 2 illustrates a system 200 which may be or include an ambient commerce system 100. The ambient commerce system 100 may be of the type described above with reference to FIG. 1, or a variation thereof. The ambient commerce system 100 may be or include a computer system. The computer system may be coupled with one or more sensors, as described with reference to FIG. 1 and may receive sensor output from such sensors.

The system 200 may also include an electronic device 130. The electronic device 130 may be as described above with reference to FIG. 1. For example, the electronic device 130 may be associated with an entity, such as a customer. The electronic device 130 may also be a computer system.

The electronic device 130 may be in communication with the ambient commerce system 100. Such communication may be via a direct connection or it may be an indirect connection. An indirect connection may be a connection that relies upon other intermediary computers or systems to relay messages. For example, as illustrated in FIG. 2, the ambient commerce system 100 and the electronic device 130 may be coupled to and communicate with one another via a network 230. The network 230 may be of various types. The network 230 may be a computer network. In some embodiments, the computer network may be an internetwork and may be formed of one or more interconnected computer networks. For example, the computer network may be or may include an Ethernet network, an asynchronous transfer mode (ATM) network, a wireless network, a telecommunications network or the like.

In some implementations, at least some communications between the electronic device 130 and the ambient commerce system 100 may occur over a direct connection. A direct connection may be a local communication method which may not require a network. For example, example direct connections include NFC, WiFi, and Bluetooth.

The ambient commerce system 100 may be or include a resource server 210. The resource server 210 may track, manage, and maintain resources, adjudicate lending requests, and/or lend resources for a plurality of entities. For example, resources available for a plurality of entities may be specified in account data for such entities. The resources may, for example, include computing resources, such as memory or processor cycles. By way of further example, the resources may include stored value, such as fiat currency, which may be represented in one or more databases. For example, as shown in FIG. 2, the resource server 210 may be coupled to a database 235, which may be provided in secure storage. The secure storage may be provided internally within the resource server 210 or externally; the secure storage may, for example, be provided remotely from the resource server 210. In some embodiments, the secure storage may include one or more data centers. The data centers may, for example, store data with bank-grade security.

The resource server 210 may include a resource request processing engine (not shown in FIG. 1). A resource request processing engine may be implemented to automatically process resource transfer requests that are received at a resource server. Specifically, the resource request processing engine may be configured to process requests to transfer resources that are associated with one or more resource accounts managed by the resource server. The resource request processing engine may process resource transfer requests in accordance with defined handling actions. For example, the resource request processing engine may be configured to automatically process resource transfer requests without manual intervention by related entities for the resource transfer requests.

The database 235 includes account data for a plurality of accounts associated with a plurality of entities. For example, the database 235 may include records for a plurality of accounts and at least some of the records may define a quantity of resources associated with an entity. For example, the entity that is associated with the electronic device 130 (which may also be referred to as a client device or customer device) may be associated with a resource account having one or more records in the database 235. The data records may reflect a quantity of stored resources that are associated with the entity. Such resources may include owned resources and, in at least some embodiments, borrowed resources (e.g., resources available on credit). The quantity of resources that are available to or associated with an entity may be reflected by a balance defined in an associated record such as, for example, a bank balance. In some implementations, a record for an account may be or include a resource parameter or enable the determination of a resource parameter. A resource parameter may, for example, indicate whether a particular entity associated with an account has access to a resource. In some implementations, the resource parameter may specify whether the particular entity associated with the account has access to a borrowed resource. In some implementations, the resource parameter may indicate a resource balance. The balance may be a balance associated with owned or borrowed resources.

The database 235 may also include identity verification data for entities having accounts in the database 235. The identity verification data may be or include a shared secret and/or biometric data such as a fingerprint, voiceprint and/or facial profile data. In at least some implementations, the resource server 210 may share at least some of the identity verification data with the ambient commerce system 100 to assist with verifying identity of an entity at an ambient commerce premises 110. In other implementations, rather than share the identity verification data itself, the resource server 210 may, instead, perform identity verification for the ambient commerce system and may confirm to the ambient commerce system the identity of an entity.

The database 235 may also include profiles for a plurality of entities. A profile may also be referred to as profile data and such data may be part of the account data, for example. A profile may be or include biographical data associated with an entity. By way of example, the profile may be or include an age identifier for the entity, such as an age or date of birth. By way of further example, the profile may be or include other information about the entity such as residential information (including, for example, a city of residence, country of residence, etc.), income information (such as an annual income), past spending or shopping information, or information about products associated with the entity (such as whether the entity has a particular credit card or information about whether the entity is a subscriber to a particular service, or information about whether is a member of a particular loyalty program).

The resource server 210 may, for example, be a financial institution system and the entity associated with an electronic device 130 may be a customer of a financial institution operating the financial institution system.

The resource server 210 may be or include a computer system. The resource server 210 may be in communication with the ambient commerce system 100. In the illustrated example, the resource server 210 is in communication with the ambient commerce system 100 via the network 230.

As illustrated in FIG. 2, the ambient commerce system 100 may also include or be connected to a datastore 245 such as a database. The datastore 245 may be or include an inventory tracking data store, which may also be referred to as an inventory or item database. In some implementations, the datastore 245 may include item and/or product data for one or more items that are physically present in the ambient commerce premises 110. By way of example, the datastore 245 may include one or more parameters associated with items available at the ambient commerce premises 110. Such parameters may be referred to as item parameters. Example item parameters may be or include a value parameter and/or a class parameter. A value parameter may be an indicator of a cost or price of an item. Put differently, the value parameter for an item may represent an amount of resources required to transfer ownership of the item to an entity. The value parameter may, in some implementations, be expressed in units of currency, such as in dollars, Euros, Francs, etc.

A class parameter may define a category or classification that an item belongs to and it may also be referred to as a category parameter. The category may represent a type of the item. By way of example, example categories may include any one or a combination of: consumer electronics, televisions, sporting goods, bicycles, financeable products, clothing, grocery items, etc.

In some instances, a particular item may be associated with multiple class parameters. By way of example, an item may be associated with a broad class parameter that defines a broad category of the item (e.g., consumer electronic) and a narrow class parameter that defines a narrow category of the item (e.g., television). In some implementations, the class parameter(s) for an item may be or include a binary class parameter. A binary class parameter is a class parameter that operates as a flag which defines whether the item is or is not a particular type of good associated with that class parameter. By way of example, a binary class parameter may indicate whether an item is financeable. In some implementations, a financeable item may be an item that is available for purchase using a buy now pay later feature.

The class parameter(s) for an item may also be or include a brand parameter. A brand parameter indicates a brand associated with the item. The brand may be a manufacturer of the item. The brand may be a brand that is reflected on packaging associated with the item.

The product data in the datastore 245 may include restriction data. The restriction data identifies at least one product whose purchase is restricted. That is, it may identify items that are restricted items. The restriction data, in some implementations, includes binary restriction data. Binary restriction data operates as a flag which defines whether the item is or is not restricted. The restriction data may also be or include non-binary restriction data. The non-binary restriction data may, for example, define a nature of a restriction. By way of example, in some implementations, a particular item may be an age-restricted item. In such implementations, the restriction data may specify a requisite age for the item. The requisite age may be a legal minimum age required for purchase of the product in a jurisdiction associated with the ambient commerce system 100. In other implementations, an item may be restricted on another basis. By way of example, it may be that the item is only available for purchase if a customer resides in a certain jurisdiction. By way of example, some products may not be available to purchase for out-of-jurisdiction purchasers. By way of further example, some products may only be available for purchase through a promotion and it may be that a customer needs to have a particular credit card or loyalty program or other service or subscription in order to purchase the item. Restriction data may define any one or more restrictions of the type defined above or elsewhere in this document.

The datastore 245 or another datastore may also include item identification data. The item identification data may be data that is used by the ambient commerce system to identify an item in the ambient commerce premises. By way of example, in a system that relies upon a code such as a barcode or QR code for identification of items, the item identification data may include a representation of the code for a particular item. By way of further example, in a system which relies upon packaging identification, the item identification data may include information about the packaging of an item. By way of further example, in a system that relies upon in-store placement information to identify items, the item identification data may include information defining a location within the ambient commerce premises at which a particular item is located. By way of example, the in-store placement information may specify an aisle number, region number, shelf number, etc. and such numbers (or other identifiers) may be known to the ambient commerce system so that the ambient commerce system is able to identify the particular items available at various regions of the ambient commerce premises.

By way of further example, in a system which relies upon a tag such as an RFID tag, the item identification data may specify a number or other identifier associated with the tag.

The ambient commerce system 100 may also include or be connected to an electronic device 280 associated with an in-store operator. The in-store operator may be an employee of a merchant operating the ambient commerce premises, for example. The electronic device 280 associated with the in-store operator may be of a type that is the same or similar to the electronic device 130 associated with the entity. By way of example, the electronic device 280 may be a laptop or desktop computer, a mobile computing device such as a smartphone, a smart watch or other wearable or an electronic device of another type. The electronic device 280 associated with the in-store operator may communicate with the ambient commerce system 100 by way of a network 230.

The ambient commerce system 100 may also include or be connected to an electrically controlled exit prevention device 290 such as an electrically controlled gate or door associated with an exit for the ambient commerce premises. The electrically controlled exit prevention device 290 may be controlled to prevent the entity from leaving the ambient commerce premises with an item that a system determines that the entity should not or cannot purchase.

In some implementations, the system 200 may include a wearable device 250. The wearable device 250 may communicate with other components of the system, such as the ambient commerce system 100. In some implementations, such communication may be via another device, such as the electronic device 130. By way of example, the wearable device 250 may be paired with the electronic device 130 and may communicate with the electronic device 130 via a short range communication protocol, such as Bluetooth™ or Bluetooth Low Energy (BLE)™. For example, the wearable device may communicate with the electronic device 130 which then communicates with other system components, such as the ambient commerce system 100 or a server or computing system associated with the ambient commerce system 100. The wearable device 250 and the electronic device 130 may be devices that are associated with a common entity, such as a common customer.

In some implementations, the communication between the wearable device 250 and the ambient commerce system 100 may not be via the electronic device 130.

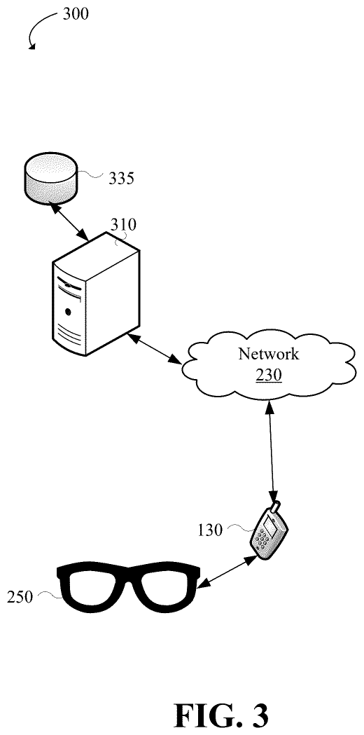

FIG. 3 is a schematic operation diagram illustrating an operating environment of another example embodiment. FIG. 3 illustrates a system 300 which may be or include a computing system 310. The computing system 310 may be or include an ambient commerce system such as the ambient commerce system 100 of FIGS. 1 and/or 2.

The system 300 may also include an electronic device 130. The electronic device 130 may be as described above with reference to FIGS. 1 and/or 2. For example, the electronic device 130 may be associated with an entity, such as a customer. The electronic device 130 may also be a computer system.

The computing system 310 may also include or be connected to a datastore 335 such as a database. The datastore 335 may be or include an inventory tracking data store, which may also be referred to as an inventory or item database. The inventory or item database may be as described above with reference to FIG. 2. For example, in some implementations, the datastore 335 may include item and/or product data for one or more.

The electronic device 130 may be in communication with the computing system 310. Such communication may be via a direct connection or it may be an indirect connection. An indirect connection may be a connection that relies upon other intermediary computers or systems to relay messages. For example, as illustrated in FIG. 3, the system 310 and the electronic device 130 may be coupled to and communicate with one another via a network 230. The network 230 may be as described above with reference to FIG. 2.

In some implementations, the system 300 may include a wearable device 250. The wearable device 250 may communicate with other components of the system, such as the computing system 310. The wearable device 250 may be as described above with reference to FIG. 2.

The system 300 of FIG. 3 may allow notifications to be generated based on engagement with an item at a premises, such as a store, even if the premises is not configured to support ambient commerce. That is, the system 300 of FIG. 3, may allow for real time notifications during a shopping session at a location that does not necessarily need to support ambient commerce. Rather, the system 300 relies upon a wearable device 250, such as smart glasses, to identify items that a customer is engaged with. Engagement may be detected by the system 300 by identifying an item that the customer is looking at. In at least some implementations, the system 300 may identify an item that the customer is about to purchase. This may be detected by determining, based on sensor data, such as camera data from smart glasses, that the customer has added the item to a shopping receptable. In another example, the system may identify an item that the customer is about to purchase by determining, based on the sensor data, that the customer is about to checkout with the item. In another example, the system 300 may identify an item that the customer is engaged with by identifying an item that the customer has picked up or touched.

The system 300 may, in at least some implementations, identify a value parameter for an item that the customer is engaged with based on sensor data from the wearable device 250. For example, a price of the item may be identified from camera data by identifying a price reflected in a tag or sign associated with the item.

Since the system 300 of FIG. 3 relies upon a wearable device 250 to detect items that a customer is engaged with and, in at least some implementations, determines a value parameter for the item based on data from the wearable device, the system 300 may be used at any shopping location, including those that do not support ambient commerce or have on-site sensing equipment.

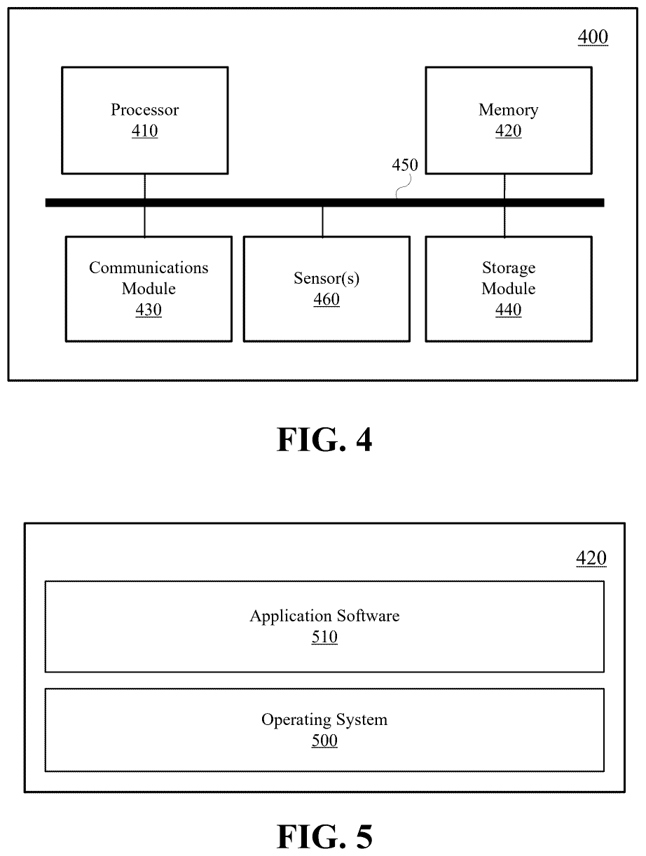

Referring now to FIG. 4, a high-level operation diagram of an example computer device 400 is shown. In some embodiments, the computer device 400 may be exemplary of one or more of the ambient commerce system 100, the computing system 310, the wearable device 250, the electronic device 130, the electronic device 280, and/or the resource server 210.

The example computer device 400 includes a variety of modules. For example, as illustrated, the example computer device 400 may include a processor 410, a memory 420, a communications module 430, and/or a storage module 4340. As illustrated, the foregoing example modules of the example computer device 400 are in communication over a bus 450.

The processor 410 is a hardware processor. The processor 410 may, for example, be one or more ARM, Intel x86, PowerPC processors or the like.

The memory 420 allows data to be stored and retrieved. The memory 420 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computer device 400.

The communications module 430 allows the example computer device 400 to communicate with other computer or computing devices and/or various communications networks. For example, the communications module 430 may allow the example computer device 400 to send or receive communications signals. Communications signals may be sent or received according to one or more protocols or according to one or more standards. For example, the communications module 430 may allow the example computer device 400 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 430 may allow the example computer device 400 to communicate using near-field communication (NFC), via Wi-Fi™, using Bluetooth™ or via some combination of one or more networks or protocols. In some embodiments, all or a portion of the communications module 430 may be integrated into a component of the example computer device 400. For example, the communications module may be integrated into a communications chipset. In some embodiments, the communications module 430 may be omitted such as, for example, if sending and receiving communications is not required in a particular application. The communications module may, in various implementations, be one or more of: a communications device, a communications interface, a communications chip, and/or a transceiver.

The storage module 440 allows the example computer device 400 to store and retrieve data. In some embodiments, the storage module 440 may be formed as a part of the memory 420 and/or may be used to access all or a portion of the memory 420. Additionally or alternatively, the storage module 440 may be used to store and retrieve data from persistent storage other than the persisted storage (if any) accessible via the memory 420. In some embodiments, the storage module 440 may be used to store and retrieve data in a database. A database may be stored in persistent storage. Additionally or alternatively, the storage module 440 may access data stored remotely such as, for example, as may be accessed using a local area network (LAN), wide area network (WAN), personal area network (PAN), and/or a storage area network (SAN). In some embodiments, the storage module 440 may access remotely stored data using the communications module 430. In some embodiments, the storage module 440 may be omitted and its function may be performed by the memory 420 and/or by the processor 410 in concert with the communications module 430 such as, for example, if data is stored remotely. The storage module may also be referred to as a data store.

Software comprising instructions is executed by the processor 410 from a computer-readable medium. For example, software may be loaded into random-access memory from persistent storage of the memory 420. Additionally or alternatively, instructions may be executed by the processor 410 directly from read-only memory of the memory 420.

When the computer device 400 is exemplary of the ambient commerce system 100, the wearable device 250, or, in at least some implementations, the electronic device 130, the computer device may include one or more sensors 460. The one or more sensors 460 may be or include any one or more of the sensors described above.

FIG. 5 depicts a simplified organization of software components stored in the memory 420 of the example computer device 400 (FIG. 4). As illustrated, these software components include an operating system 500 and an application 510.

The operating system 500 is software. The operating system 500 allows the application 510 to access the processor 410 (FIG. 4), the memory 420, and the communications module 430 of the example computer device 400 (FIG. 4). The operating system 500 may be, for example, Google™ Android™, Apple™ iOS™, UNIX™, Linux™, Microsoft™ Windows™, Apple OSX™ or the like.

The application 510 adapts the example computer device 400, in combination with the operating system 500, to operate as a device performing a particular function. For example, the application 510 may cooperate with the operating system 500 to adapt a suitable embodiment of the example computer device 400 to operate as the ambient commerce system 100, the resource server 210 and/or the electronic device 130.

While a single application 510 is illustrated in FIG. 5, in operation the memory 420 may include more than one application 510 and different applications 510 may perform different operations.

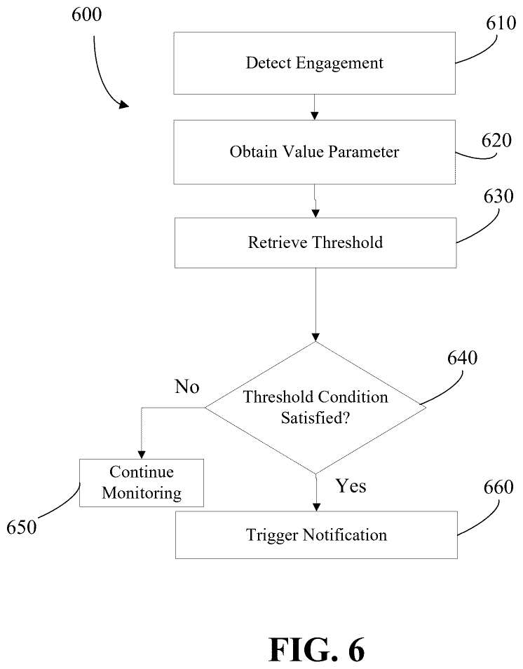

FIG. 6 is a flowchart showing operations performed by a system 200, 300, such as the ambient commerce system 100 (FIGS. 1 and 2) and/or the resource server 210 (FIG. 2) and/or the computing system 310 (FIG. 3), the electronic device 130 and/or the wearable device 250 (FIG. 3). The operations may be included in a method 600 which may be performed by the ambient commerce system 100 (FIGS. 1 and 2), the electronic device 130 and/or the resource server 210 (FIG. 2) and/or the computing system 310 (FIG. 3), the electronic device 130 and/or the wearable device 250 (FIG. 3). For example, computer-executable instructions stored in memory of the ambient commerce system 100 (FIGS. 1 and 2) and/or the resource server 210 (FIG. 2) and/or the computing system 310 (FIG. 3) and/or the electronic device 130 and/or the wearable device 250 (FIG. 3) may, when executed by one or more processors of the ambient commerce system 100 (FIGS. 1 and 2) and/or the electronic device 130 and/or the resource server 210 (FIG. 2) and/or the computing system 310 (FIG. 3) and/or the electronic device 130 and/or the wearable device 250 (FIG. 3), configure the ambient commerce system 100 (FIGS. 1 and 2) and/or the resource server 210 (FIG. 2) and/or the computing system 310 (FIG. 3) and/or the electronic device 130 and/or the wearable device 250 (FIG. 3) to perform the method 600 or a portion thereof.

At operation 610, the system performing the method 600 detects engagement with an item. Such engagement may be detected during a commerce session at a physical location. The engagement may be detected based on an output of a sensor. The sensor may be of various types. For example, the sensor may be of a type described above. For example, the sensor may be a sensor associated with an ambient commerce system. The sensor may be on site at the physical location. In some implementations, the sensor may include a receptable contents detector 146. In some implementations, the sensor may include one or more cameras. The cameras may be permanently installed on site at the physical location or they may be movable. For example, in some implementations, the sensor may be a camera included in or on a customer's device, such as an electronic device 130 associated with an entity. In some implementations, the sensor may be a camera included in or on a wearable device 250. For example, the sensor may be provided on smart glasses. The smart glasses may be associated with an entity which may be associated with stored threshold definition data.

In at least some implementations, the system that performs the method 600 of FIG. 6 may not interact with a merchant system. That is, the system that performs the method 600 may not interact with any system associated with a sensor that is permanently installed at or situated within the physical location at which the commerce sensor occurs. For example, the system may be of the type described above with reference to FIG. 3.

Engagement may be detected in various ways. For example, in some implementations, engagement may be detected by detecting a dwell on an item. That is, the system may determine that the entity is engaged with an item by detecting a dwell at a region associated with the item.

In some implementations, entity engagement with an may be determined to have occurred when a dwell of an entity is detected in a geofence for an item. A dwell may be detected, for example, when the entity has not substantially moved for at least a threshold period of time. The threshold period of time may be a period of time that suggests that the entity is browsing; that is, contemplating a purchase. In other implementations, the dwell may be detected if it is determined that the entity has remained in the geofence for the item for at least a threshold period of time. By way of example, the geofence may be or include a particular aisle or region or a portion thereof within an ambient commerce premises. The geofence may be an area of the ambient commerce premises in which particular items are located.

In another example of a technique that may be used to identify engagement with the item, the ambient commerce system 100 may identify engagement with the item when it detects that the entity has picked up the item. The picking up of an item may be detected using a sensor output of a camera 140a, 140b, for example. The camera may be included on or in a wearable device 250 such as smart glasses.

In another example of a technique that may be used to detect engagement with the item, the ambient commerce system 100 may identify engagement with the item when the item is added to a shopping receptacle 170 associated with the entity, such as a shopping receptable in use by the entity. The ambient commerce system 100 may identify that the item has been added to a shopping receptacle 170 based on the output of a receptacle contents detector 146 and/or based on the output of a camera 140a, 140b. The camera may be included on or in a wearable device 250 such as smart glasses.

In another example of a technique that may be used to detect engagement with the item, the ambient commerce system 100 may identify engagement with the item based on detected browsing activity of the entity with the item. By way of example, engagement may be detected when the entity is determined to have examined a price tag for the item. By way of further example, engagement may be detected when the entity is determined to have contacted (e.g., touched) the item. By way of further example, engagement may be detected when the entity is determined to have looked at the item. In some implementations, a time threshold may be used to detect engagement. For example, engagement may be detected when the entity is determined to have looked at the item for at least a threshold period of time. These types of engagement may be detected based on the output of a camera 140a, 140b. The camera may be included on or in a wearable device 250 such as smart glasses.

At an operation 620, the computing system performing the method 600 may obtain a value parameter for the item. The value parameter for the item may represent a price or cost of the item. The value parameter may be a numerical indicator.

The value parameter for the item may be obtained using a variety of techniques. In at least some implementations, such as implementations in which the sensor is a camera, the value parameter may be obtained from camera data output by the camera. By way of example, in implementations in which the computing system performing the method 600 does not communicate with any merchant systems, the value parameter may be obtained from camera data. The value parameter may be obtained from the camera data by performing optical character recognition (OCR) on an image defined by the camera data or a portion thereof. For example, the computing system may identify a price tag associated with the item and may then identify a price reflected on the price tag using OCR or other techniques. Conveniently, by using such techniques for identifying the value parameter, the computing system performing the method 600 need not communicate with any merchant system.

In other implementations, such as implementations in which a merchant system is engaged in the performance of the method 600, the computing system performing the method 600 may obtain the value parameter from a datastore 245. The datastore 245 may be, for example, an inventory tracking data store, such as an inventory or item database.

At an operation 630 of the method 600, the computing system performing the method 600 may retrieve a threshold. The threshold may be retrieved from stored threshold definition data. The threshold may be a threshold that is specific to a particular entity. More specifically, it is a threshold that is associated with the entity engaged in the commerce session.

The threshold may be of various types. For example, in some implementations, the threshold may represent a balance associated with an account. The balance may represent an amount of resources that are available to be used in association with the account. The account may be an account that is associated with the particular entity.

The threshold may, in other implementations, represent a resource allocation parameter. The resource allocation parameter may be, for example, a budget. The threshold may be defined in threshold definition data. The threshold may be associated with the particular entity. The threshold may be retrieved from a datastore at the operation 630. The retrieval may be based on an identification of the particular entity.

The computing system performing the method 600 may determine whether a threshold condition is satisfied at an operation 640. A threshold condition is a condition that is associated with a threshold. That is, the computing system may evaluate the value parameter obtained at the operation 620 using the threshold retrieved at the operation 630. By way of example, the computing system may determine whether purchase of the item should be permitted based on the value parameter. The computing system may determine whether the item should, or should not, be purchased. By way of example, if a purchase of the item would offend the threshold or be prevented by the threshold, then the computing system may determine that the item should not be purchased. In some implementations, the computing system may determine that the item should not be purchased when it determines that the entity does not have sufficient resources to complete the purchase. In some implementations, the computing system may determine that the item should not be purchased when it determines that purchase of the item would violate a budget associated with the entity.

When performing the operation 640, the computing system may perform the evaluation based also on the value parameter of one or more other items that are expected to be purchased in the commerce session. These may be items that were previously added to a shopping receptable during the commerce session. In some implementations, the computing system performing the method 600 may maintain an updated running total of the expected value of a current commerce session and may update this running total based on any items that the entity is determined, at the operation 610, to be engaged with. This running total may be used in the evaluation. For example, the running total may be evaluated based on the retrieved threshold. Notably, the operation 640 may be performed during a commerce session in real time as a customer is engaged with an item. The operation 640 (and, the operation 660) may be performed prior to any checkout, for example.

The computing system performing the method 600 may, based on the result of the evaluation, selectively perform a computing operation, such as triggering a notification. The notification may be triggered at a device that is associated with the threshold definition data. For example, the notification may be triggered on the electronic device 130 associated with the entity engaged in the commerce session. In some implementations, the notification may be triggered on a wearable device 250. The notification may be for, example, an audible or visual notification.

As noted above, the notification is selectively triggered. By way of example, if, at the operation 640, the computing system performing the method 600 determines that the threshold condition has not been satisfied (e.g., that the item may be purchased), it may continue monitoring at an operation 640 and may not trigger the notification. In some implementations, this operation may include monitoring for engagement with further items. For example, a further iteration of the operation 610 may be performed.

By way of a further example of the selective triggering, if, at the operation 640, the computing system performing the method 600 determines that the threshold condition has been satisfied (e.g., that the item should not be purchased based on the threshold definition data), it may trigger the notification at an operation 660. The notification may, for example, indicate that the item should not be purchased.

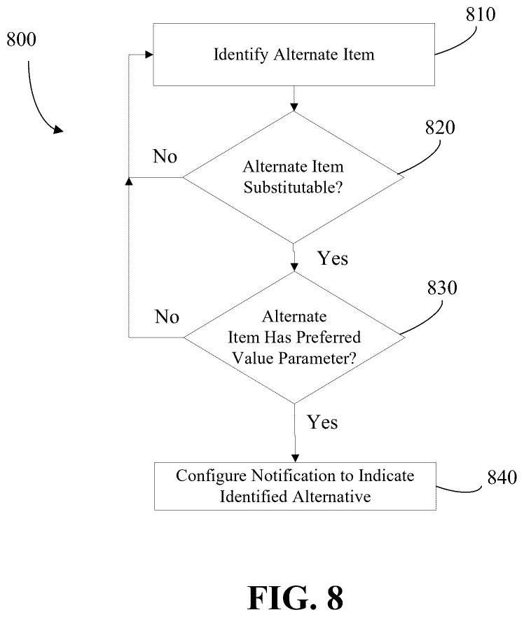

The notification may include various features. In some implementations, the notification may include a suggestion of an alternate item. The alternate item may also be referred to herein as an alternative item. Example techniques of identifying an alternate item will be discussed below with reference to FIG. 8. The alternate item may be an item that is similar to the item that the entity is engaged with, but which has a reduced value parameter. That is, the alternate item may be an item that is more affordable than the item that the entity is engaged with, but which serves a same or similar function or purpose.

The notification may indicate a location within the physical premises of the alternate item. In implementations in which the notification is provided on a wearable device such as smart glasses, the smart glasses may provide an augmented reality display that highlights the item within the physical premises. For example, the smart glasses may highlight the item may modifying camera data to highlight the location of the item. This may include, for example, any one or more of: displaying arrows or other navigational indicators indicating a path of travel to reach the item, displaying a circle or other highlighting feature in or around a portion of an image that represents the item or outputting audible indicators to facilitate navigation to the item and/or to highlight a location of the item.

The notification may include a selectable option to access a borrowed resource. The selectable option may be displayed, for example, when the computing system performing the method 600 determines, at the operation 640, that the entity does not have sufficient resources to purchase the item. The selectable option to access a borrowed resource may be activated to apply for or otherwise obtain access to a non-owned resource. Activation of the selectable option may cause the computing system performing the method 600 or another computing system to enable access to the borrowed resource. By enabling access to the borrowed resource, the entity may be able to complete a transfer that they would not otherwise be able to complete.

The notification may, in at least some implementations, include a selectable option to split a transfer into multiple parts. The selectable option may be referred to as a buy now, pay later selectable option. The selectable option may be displayed, for example, when the computing system performing the method 600 determines, at the operation 640, that the entity does not have sufficient resources to purchase the item. In at least some implementations, activation of the selectable option may cause the computing system performing the method 600 or another computing system to enable a multi-part transfer. By enabling the multi-part transfer, the entity may be able to complete a transfer that they would not otherwise be able to complete by splitting the transfer into multiple parts so that at least a portion of the transfer is deferred.

The notification may, in at least some implementations, include a selectable option to access an accumulated resource. An accumulated resource may be a resource that has accumulated at a third party system. For example, the accumulated resource may be or represent earned wages. Earned wage access (EWA) is a service offered to employees by an employer providing access to some of their accrued wages before the end of their payroll cycle. EWA is also known as instant pay, earned income, early wage access, accrued wage access, salary advance scheme and/or on demand pay. Employees may use an application to transfer earned wages to their bank account, debit card, or payroll card. In at least some implementations, the selectable option to access the accumulated resource is only displayed when certain conditions are satisfied. For example, the selectable option may be displayed, for example, when the computing system performing the method 600 determines, at the operation 640, that the entity does not have sufficient resources to purchase the item. Additionally or alternatively, in at least some implementations, the displaying of the selectable option may be conditional upon the computing system performing the method 600 determining that accumulated resources are available and/or determining that an amount of earned wages that is sufficient to enable completion of purchase of the item is available. Activation of the selectable option to access earned wages may cause the computing system performing the method 600 or another computing system to access earned wages. This may include performing an application programming interface (API) call to an earned wage access system to cause the earned wages or a portion thereof to be transferred to the account associated with the entity. By accessing earned wages, the entity may be able to complete a transfer that they would not otherwise be able to complete.

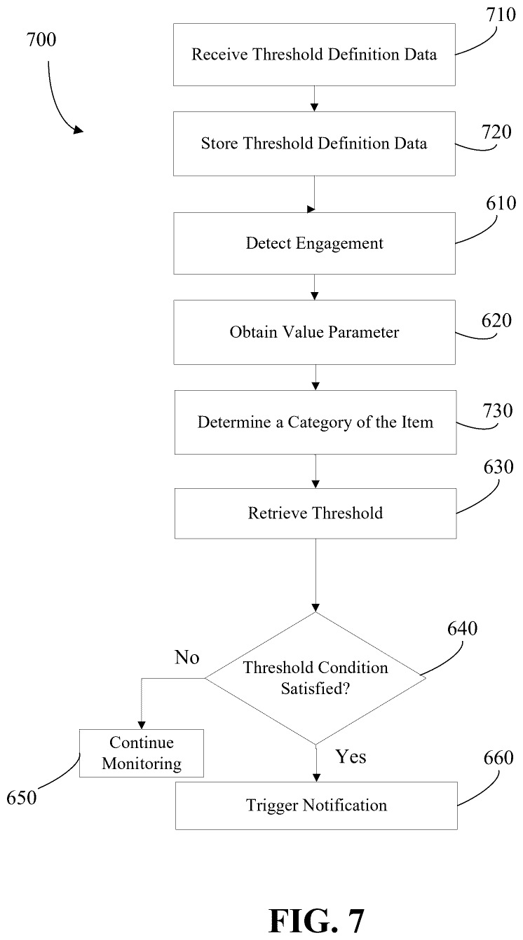

Variations of the method 600 are contemplated. Reference will now be made to FIG. 7, which illustrates one possible variation. FIG. 7 is a flowchart showing operations performed by a system 200, 300, such as the ambient commerce system 100 (FIGS. 1 and 2) and/or the resource server 210 (FIG. 2) and/or the computing system 310 (FIG. 3), the electronic device 130 and/or the wearable device 250 (FIG. 3). The operations may be included in a method 700 which may be performed by the ambient commerce system 100 (FIGS. 1 and 2), the electronic device 130 and/or the resource server 210 (FIG. 2) and/or the computing system 310 (FIG. 3), the electronic device 130 and/or the wearable device 250 (FIG. 3). For example, computer-executable instructions stored in memory of the ambient commerce system 100 (FIGS. 1 and 2) and/or the resource server 210 (FIG. 2) and/or the computing system 310 (FIG. 3) and/or the electronic device 130 and/or the wearable device 250 (FIG. 3) may, when executed by one or more processors of the ambient commerce system 100 (FIGS. 1 and 2) and/or the electronic device 130 and/or the resource server 210 (FIG. 2) and/or the computing system 310 (FIG. 3) and/or the electronic device 130 and/or the wearable device 250 (FIG. 3), configure the ambient commerce system 100 (FIGS. 1 and 2) and/or the resource server 210 (FIG. 2) and/or the computing system 310 (FIG. 3) and/or the electronic device 130 and/or the wearable device 250 (FIG. 3) to perform the method 700 or a portion thereof.

The method 700 of FIG. 7 includes operations in common with the method 600 of FIG. 6. Such operations are indicated with common reference numerals and the discussion of such operations will not be repeated at length.

The method 700 illustrates how a threshold may be defined and later used for real-time triggering during an ambient commerce session.

At an operation 710, the computing system performing the method 700 receives threshold definition data. The threshold definition data defines at least one threshold. The threshold may be or represent a budget.

In at least some implementations, the threshold definition data may define a threshold for each of a plurality of categories. The categories may be or include for example, any one or more of: groceries, clothing, sporting equipment, discretionary expenses, rent or mortgage costs, utilities, etc. The categories may represent spending types and/or types of items.

The threshold definition data may be received via an interface. The interface may be an interface that is output on an electronic device 130 associated with a particular entity. The threshold definition data may be received after an entity has been authenticated as being associated with a particular account. Such authentication may be performed using a credential, such as a password. In at least some implementations, the authentication may be performed using biometric data, such as a fingerprint.

The interface that is used for inputting the threshold definition data may be provided on or by an application 510 (FIG. 5).

The computing system performing the method 700 may, at an operation 720, store the threshold definition data. The threshold definition data may be stored in a datastore such as in the database 235 of FIG. 2, the datastore 245 of FIG. 2 and/or the datastore 335 of FIG. 3. Which database or datastore is used may depend on which computing system performs the operation 710.

The method 700 may include the operations 610 and 620 described above with reference to FIG. 6 wherein the computing system detects engagement with an item (operation 610) and obtains a value parameter for that item (operation 620).

At an operation 730, the computing system performing the method 700 may determine a category of the item that the entity is engaged with (as identified at the operation 610). The category of the item may be a category corresponding to one or more of the categories that are associated with thresholds defined by the threshold definition data. For example, the categories may be or include any one or more of: groceries, clothing, sporting equipment, discretionary expenses, rent or mortgage costs, utilities, etc. The categories may represent spending types and/or types of items.

The method 700 may include the operation 630 in which a threshold is retrieved. In implementations in which categories are used, the threshold may be retrieved from the stored threshold definition data by retrieving an appropriate threshold based on the category of the item, as determined at the operation 730.

In this way, the computing system may track various categories of spending in real time during an ambient commerce shopping session.

The method 700 of FIG. 7 may include the operations 640, 650 and/or 660 of FIG. 6, all of which are discussed above with reference to FIG. 6. The notification may be generated when a purchase of an item would violate any one of the defined thresholds.

Reference will now be made to FIG. 8, which illustrates one possible variation. FIG. 8 is a flowchart showing operations performed by a system 200, 300, such as the ambient commerce system 100 (FIGS. 1 and 2) and/or the resource server 210 (FIG. 2) and/or the computing system 310 (FIG. 3), the electronic device 130 and/or the wearable device 250 (FIG. 3). The operations may be included in a method 800 which may be performed by the ambient commerce system 100 (FIGS. 1 and 2), the electronic device 130 and/or the resource server 210 (FIG. 2) and/or the computing system 310 (FIG. 3), the electronic device 130 and/or the wearable device 250 (FIG. 3). For example, computer-executable instructions stored in memory of the ambient commerce system 100 (FIGS. 1 and 2) and/or the resource server 210 (FIG. 2) and/or the computing system 310 (FIG. 3) and/or the electronic device 130 and/or the wearable device 250 (FIG. 3) may, when executed by one or more processors of the ambient commerce system 100 (FIGS. 1 and 2) and/or the electronic device 130 and/or the resource server 210 (FIG. 2) and/or the computing system 310 (FIG. 3) and/or the electronic device 130 and/or the wearable device 250 (FIG. 3), configure the ambient commerce system 100 (FIGS. 1 and 2) and/or the resource server 210 (FIG. 2) and/or the computing system 310 (FIG. 3) and/or the electronic device 130 and/or the wearable device 250 (FIG. 3) to perform the method 800 or a portion thereof.

The method 800 of FIG. 8 may be performed together with other methods described herein such as any one or more of the methods 600, 700, 900 of FIGS. 6, 7 and 9. In at least some implementations, the method 800 may be performed in response to determining that the threshold condition is satisfied at the operation 640. For example, the method 800 may be performed in response to determining, based on the value parameter of the item that the entity is engaged with, that the item should not be purchased.

The method 800 may include, at an operation 810, identifying an alternate item. The alternate item may be identified from sensor data. For example, the alternate item may be identified from camera data. The alternate item may be an item that is depicted in the camera data.

At an operation 820, the computing system performing the method 800 may determine whether the identified alternate item is substitutable with the item for which engagement was detected. Determining that the alternate item is substitutable with the item for which engagement was detected may include determining that the alternate item is in a same category as the item for which engagement was detected. The determination may be based on data defined in an inventory tracking data store, which may also be referred to as an inventory or item database.

If the alternate item is determined to not be substitutable, the computing system may continue to monitor for other alternate items at the operation 810. If the alternate item is determined to be substitutable, the computing system may determine whether the alternate item has a preferred value parameter at operation 830. The value parameter for the alternate item may be identified in the same manner that the value parameter for the item for which engagement is detected is determined. For example, the techniques described with reference to operation 620 of the method 600 may be used to identify the value parameter of the alternate item. The value parameters for each of the items may be compared at the operation 830 to determine whether the alternate item has a preferred value parameter. A preferred value parameter may be a lesser value parameter.

In at least some implementations, when determining whether the alternate item has a preferred value parameter, the computing system may consider a size parameter of the engaged item and a size parameter of the alternate item. The size parameter may be a size of the item. The size parameter may be expressed in a number of units included in the item, a weight of the item, a volume of the item, etc. The computing system may determine a normalized value parameter for each of the items and the normalized values may be used in the comparison that is used to determine whether the alternate item has a preferred value parameter.

If the alternate item has a preferred value parameter, the notification that is provided at the operation 660 of the methods 600, 700, 900 may be configured to include an indication of the alternate item. For example, it may indicate that the item for which engagement was detected should be substituted with the alternate item. The notification may be configured at the operation 840.

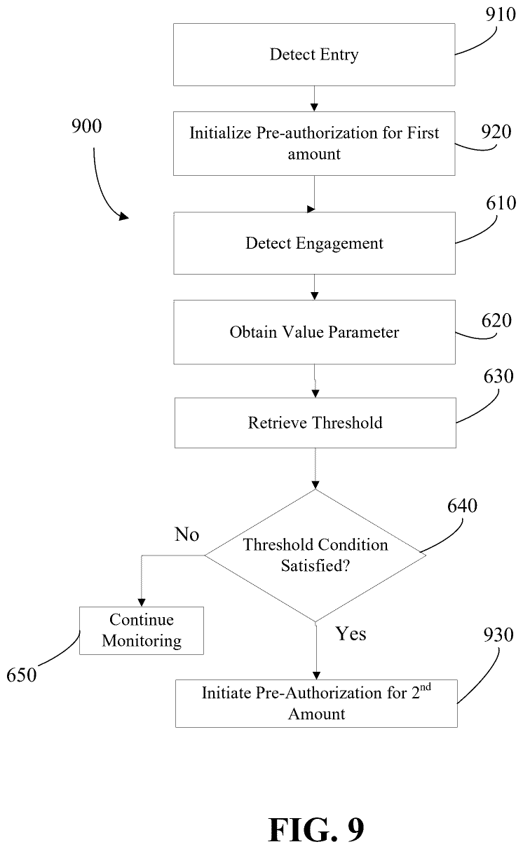

Reference will now be made to FIG. 9, which illustrates a further possible method 900. FIG. 9 is a flowchart showing operations performed by a system 200, 300, such as the ambient commerce system 100 (FIGS. 1 and 2) and/or the resource server 210 (FIG. 2) and/or the computing system 310 (FIG. 3), the electronic device 130 and/or the wearable device 250 (FIG. 3). The operations may be included in a method 900 which may be performed by the ambient commerce system 100 (FIGS. 1 and 2), the electronic device 130 and/or the resource server 210 (FIG. 2) and/or the computing system 310 (FIG. 3), the electronic device 130 and/or the wearable device 250 (FIG. 3). For example, computer-executable instructions stored in memory of the ambient commerce system 100 (FIGS. 1 and 2) and/or the resource server 210 (FIG. 2) and/or the computing system 310 (FIG. 3) and/or the electronic device 130 and/or the wearable device 250 (FIG. 3) may, when executed by one or more processors of the ambient commerce system 100 (FIGS. 1 and 2) and/or the electronic device 130 and/or the resource server 210 (FIG. 2) and/or the computing system 310 (FIG. 3) and/or the electronic device 130 and/or the wearable device 250 (FIG. 3), configure the ambient commerce system 100 (FIGS. 1 and 2) and/or the resource server 210 (FIG. 2) and/or the computing system 310 (FIG. 3) and/or the electronic device 130 and/or the wearable device 250 (FIG. 3) to perform the method 900 or a portion thereof.

The method 900 may include operations described above with reference to the method 600 of FIG. 6. The discussion of such operations will not be repeated at length. The method 900 may include other operations not specifically illustrated in FIG. 9. For example, the operations of the method 700 and/or of the method 800 may be included.

In some implementations, the method 900 may be used to provide stepped-up pre-authorizations. For example, when an entity enters a physical premises associated with an ambient commerce system, a pre-authorization may be processed and the amount of the pre-authorization may be dynamically adjusted based on sensed activity during a commerce session.

For example, at an operation 910, the computing system performing the method 900 may detect entry of the entity within a premises associated with an ambient commerce system. Such entry may be detected using a sensor such as a camera. The entity may be identified and associated with a particular account. That account may have a token associated with the account, such as a payment token.

At an operation 920, the computing system performing the method 900 may initialize a pre-authorization of a first amount. The first amount may be a default amount. The default amount may be common to all entities or it may be entity-specific. Where it is entity specific, it may be determined based on past transactions. For example, it may be determined as an average of a defined number of recent transactions.

The pre-authorization may be initialized using the token associated with the entity's account. The pre-authorization may be a hold. The pre-authorization may also be referred to as an authorization hold, a card authorization or a preauth.

The method 900 may then detect engagement with an item at an operation 610, which is described above with reference to FIG. 6 and it may determine a value parameter of that item at an operation 620 as described above with reference to FIG. 6. Then, at an operation 630, a threshold may be retrieved. The threshold may be based on the amount of the pre-authorization. For example, where the pre-authorization is for a first amount, the threshold may be the first amount.

At an operation 640, the computing system performing the method 900 may determine if a threshold condition is satisfied. This may include determining if a purchase of the item, would cause the threshold to be exceeded. In making this determination, the computing system may take into account other items that the entity is expected to purchase in the same transaction, such as items in a shopping receptacle. Accordingly, at the operation 640, evaluating the value parameter using the retrieved threshold may include determining that the first amount is insufficient based on the value parameter.

The computing system performing the method 900 may, in response to determining that the threshold condition is satisfied (i.e., that the first amount is insufficient), perform an operation 930 in which it initializes a pre-authorization of a second amount. The second amount may be an amount that is sufficient based on the value parameter. That is, the second amount is an amount that is sufficient to allow for completion of a transaction that includes the item.

If, instead, the threshold condition is not satisfied, then the computing system may continue monitoring at the operation 650, described above with reference to FIG. 6.

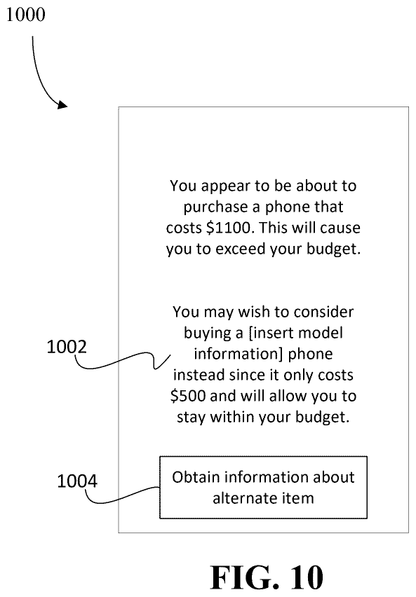

Reference will now be made to FIG. 10 which shows an example notification 1000. The example notification 1000 may be displayed at an operation 660 of one of the methods described herein. The notification may include an indication 1002 of a suggestion of an alternate item. The notification 1000 may include a selectable option 1004. In the illustrated example, the selectable option 1004 is a selectable option to obtain more information about the suggested alternate item.

The methods described above may be modified. For example, other computer operations may be performed in response to determining that the threshold condition is satisfied. By way of example, in some implementations, an electrically controlled gate may be controlled based on the result of the evaluation at the operation 640. In some implementations, the electrically controlled gate may be controlled to prevent an entity from leaving a physical premises with an item that should not be purchased based on the threshold. For example, if purchasing the item would violate a budget, then the electrically controlled gate may be controlled to prevent the entity from exiting the physical location with that item.

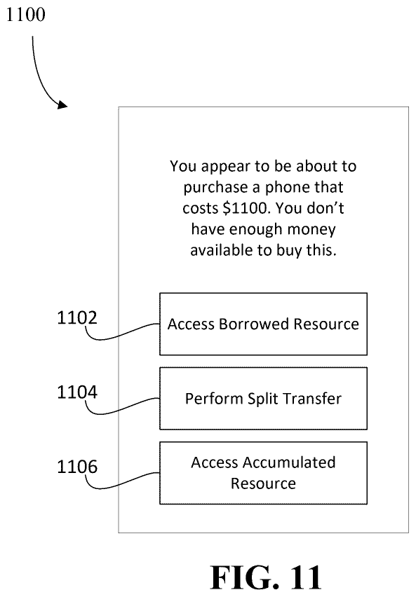

Reference will now be made to FIG. 11 which shows a further example notification 1100. The example notification 1100 may be displayed at an operation 660 of one of the methods described herein. The notification 1100 may include one or more selectable options 1102, 1104, 1106. In the illustrated example, the selectable options include a selectable option 1102 to access a borrowed resource, a selectable option 1104 to perform a split transfer and a selectable option 1106 to access accumulated resources. These selectable options may be as described above. Not all of these options are included in the notification 1100 in all implementations.

Any examples involving a general-purpose computer, aspects of this application transform the general-purpose computer into a special-purpose computing device when configured to execute the instructions described herein.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

1. A computing system comprising:
a sensor for sensing one or more parameters of a session at a physical location;
a processor coupled to the sensor; and
a memory coupled to the processor, the memory storing processor-executable instructions which, when executed, cause the processor to:
detect, based on an output of the sensor, engagement with an item during the session at the physical location;
obtain a value parameter for the item;
retrieve a threshold from stored threshold definition data;
evaluate the value parameter using the retrieved threshold; and
based on a result of the evaluation, selectively trigger a notification at a device associated with the threshold definition data.

2. The computing system of claim 1, wherein the instructions further configure the processor to:
receive, via an interface, threshold definition data defining thresholds for each of a plurality of categories; and
determine a category of the item,
and wherein retrieving the threshold from the stored threshold definition data includes retrieving the threshold based on the category of the item.

3. The computing system of claim 1, wherein the threshold represents a balance associated with an account.

4. The computing system of claim 1, wherein the sensor is provided on smart glasses associated with the threshold definition data.

5. The computing system of claim 4, wherein the computing system does not interact with a merchant system.

6. The computing system of claim 1, wherein evaluating the value parameter using the retrieved threshold includes determining that the item should not be purchased based on the threshold definition data and wherein the notification is triggered in response to determining that the item should not be purchased based on the threshold definition data and wherein the notification indicates that the item should not be purchased.

7. The computing system of claim 1, wherein the notification includes one or more of:
a suggestion of an alternate item;
a selectable option to access a borrowed resource;
a selectable option to split a transfer into multiple parts; and
a selectable option to access an accumulated resource.

8. The computing system of claim 1, wherein detecting engagement with the item includes detecting a dwell at a region associated with the item.

9. The computing system of claim 1, wherein detecting engagement with the item includes determining that the item has been added to a shopping receptacle.

10. The computing system of claim 1, wherein the sensor is a camera and wherein obtaining the value parameter includes obtaining the value parameter from camera data.

11. The computing system of claim 10, wherein obtaining the value parameter from camera data includes performing optical character recognition on an image defined by the camera data.

12. The computing system of claim 10, wherein the instructions further configure the processor to:
identify an alternate item depicted in the camera data;
determine that the alternate item and the item for which engagement was detected are substitutable; and
determine, from the camera data, that the alternate item has a preferred value parameter, wherein the notification indicates that the item for which engagement was detected should be substituted with the alternate item.

13. The computing system of claim 1, wherein the instructions further configure the processor to:
initialize a pre-authorization of a first amount to initiate the session, and wherein the threshold is based on the first amount,
and wherein evaluating the value parameter using the retrieved threshold includes determining that the first amount is insufficient based on the value parameter,
and wherein the instructions further configure the processor to, in response to determining that the first amount is insufficient based on the value parameter, initialize a pre-authorization of a second amount.

14. A computer-implemented method comprising:
detecting, based on an output of a sensor, engagement with an item during a session at a physical location;
obtaining a value parameter for the item;
retrieving a threshold from stored threshold definition data;
evaluating the value parameter using the retrieved threshold; and
based on a result of the evaluation, selectively triggering a notification at a device associated with the threshold definition data.

15. The computer-implemented method of claim 14, further comprising:
receiving, via an interface, the threshold definition data, the threshold definition data defining thresholds for each of a plurality of categories; and
determining a category of the item,
and wherein retrieving the threshold from the stored threshold definition data includes retrieving the threshold based on the category of the item.

16. The computer-implemented method of claim 14, wherein the threshold represents a balance associated with an account.

17. The computer-implemented method of claim 14, wherein the sensor is provided on smart glasses associated with the threshold definition data.

18. The computer-implemented method of claim 17, wherein a computing system performing the method does not interact with a merchant system.

19. The computer-implemented method of claim 14, wherein evaluating the value parameter using the retrieved threshold includes determining that the item should not be purchased based on the threshold definition data and wherein the notification is triggered in response to determining that the item should not be purchased based on the threshold definition data and wherein the notification indicates that the item should not be purchased.

20. (canceled)

21. The computing system of claim 1, wherein the computing system further includes an identity sensor, and the instructions further configure the processor to:
verify, based on an output of the identity sensor, an entity of the device using image recognition.
